(19) United States
(12) Patent Application Publication
(10) Pub. No.: US 2020/0306723 A1
(43) Pub. Date: Oct. 1, 2020

(54) STORAGE MATERIAL AND METHOD FOR CHLORINE STORAGE

(71) Applicant: Covestro Deutschland AG

(72) Inventors: Vinh TRIEU, Köln (DE); Gerhard LANGSTEIN, Kürten (DE); Paul HEINZ, Leverkusen (DE); Rainer WEBER, Odenthal (DE); Yuliya SCHIEßER, Troisdorf (DE); Knud WERNER, Krefeld (DE); Verena HAVERKAMP, Bergisch Gladbach (DE); Sebastian POLARZ, Meersburg (DE); Andreas SCHACHTSCHNEIDER, Konstanz (DE)

(21) Appl. No.: 16/310,877

(22) PCT Filed: Jun. 19, 2017
(86) PCT No.: PCT/EP2017/064903

§ 371 Date: Dec. 18, 2018

(30) Foreign Application Priority Data
Jun. 20, 2016 (EP) 16175348.8

(51) Int. Cl. B01J 20/10; B01J 20/28; C01B 7/075

(52) U.S. Cl. CPC B01J 20/103; B01J 20/2808; B01J 20/28083; B01J 20/28004; B01D 53/02; B01J 20/28011; B01J 20/28057; C01B 7/075; B01J 20/2809

(57) ABSTRACT

The invention relates to a novel storage material on the basis of nanoporous silicon dioxide particles for the adsorption of chlorine, to the use of said storage material for chlorine recovery and for chlorine liquefaction for the purpose of storing, transport and cleaning.

The invention relates to a novel storage material based on nanoporous silicon dioxide particles for the adsorption of chlorine, to the use of this storage material for chlorine recovery and for chlorine liquefaction for the purpose of storage, transport and purification.

The invention starts from storage material known per se based on modified silicon dioxides which have become known in the prior art for the absorptive storage of liquid chlorine.

In the industrial production and use of chlorine, there are various process steps which are capable of being optimized. These include chlorine liquefaction for the purposes of storage and transport of liquefied chlorine and for the purposes of purification and chlorine recovery from chlorine-containing process gas.

For industrial use, chlorine is stored and transported to the respective points of consumption in liquid form, whereby transport takes place via pipelines or also above ground by road or rail. The chlorine is thereby generally in liquid form at room temperature under elevated pressure of, for example, approximately 7 bar. Alternatively, chlorine can also be stored at low pressures, but then also at the same time at very low temperatures in the region of −35° C. When storing and also when transporting chlorine, it would be desirable to be able to work under changed conditions at a lower pressure or a higher temperature, in order to reduce energy costs. In addition, it would also be highly advantageous, from the point of view of operational safety, to be able to handle a lower vessel pressure. If the chlorine is, for example, at a lower pressure than the equilibrium vapor pressure at room temperature (approximately 7 bar), it cannot escape so quickly in the event of a leak, and time would be gained for taking corresponding protective and repair measures.

The liquefaction of chlorine is also used in the purification thereof in order to separate off impurities formed during the production process. These impurities include other gases such as oxygen, nitrogen or carbon dioxide, which have lower boiling points than chlorine and can thus be separated off by liquefying the chlorine. In chlorine liquefaction, the high energy outlay for cooling the chlorine and the energy costs associated therewith are a major disadvantage. It would here be desirable to achieve liquefaction under conditions with a lower pressure or at a higher temperature (e.g. a pressure p<7 bar at room temperature or a temperature T>−35° C. at atmospheric pressure) and thus with a lower energy outlay, which would reduce the energy costs associated therewith considerably.

The above-described procedures for the liquefaction of chlorine for the purpose of storage and transport and purification are conventional in the prior art. Alternative methods of liquefying chlorine for these applications under milder conditions, and thus achieving advantages in respect of energy consumption, energy costs and also safety, have not yet been described.

In the production of chlorine, and also in other chemical productions which use chlorine, various process gases which contain residual amounts of chlorine are formed. The chlorine is generally removed from the process gas by chemical reaction, for example with sodium hydroxide solution, whereby it is no longer in the form of usable chlorine. It can also be removed by physical absorption with organic solvents, for example with carbon tetrachloride, whereby the chlorine is likewise no longer usable directly for chemical processing because it contains organic impurities. It would be desirable here to recover the chlorine from the process gas in a simple manner without impurities and thus render it usable again for the chemical reaction.

For the recovery of chlorine from process gases, the adsorption of chlorine on porous solids by the process of pressure swing absorption (PSA) is described. In EP0741108A2 there are proposed as adsorbents for chlorine zeolites, non-zeolite porous acidic oxides, active carbon and molecular sieve carbon. U.S. Pat. No. 5,376,164A1 describes as adsorbents molecular sieves including zeolite sieves, active carbon, active clay, silica gel, and activated aluminum oxide. The chlorine adsorption measurements on various zeolites and silica gel which are described in U.S. Pat. No. 5,376,164A1 show a maximum chlorine uptake capacity under the particular measuring conditions (room temperature, maximum 0.87 bar) of <0.2 g of chlorine per g of storage material, which is very low and too expensive for industrial application.

In [J. Phys. Chem., 1942, 46 (1), pp. 31-35], chlorine adsorption on silica gel was studied at an early stage, whereby the chlorine uptake capacity of the silica gel under the measuring conditions (−26° C., maximum 0.97 bar) is 0.26 g of chlorine per g of storage material. Measurements of the chlorine adsorption on mesoporous silicon dioxide (MCM-41, MCM-48) have been described in [W. Q. Xiao, dissertation, Chlorine Adsorption Properties of NaX, NaY, MCM-41, MCM-48 and Mordenite Molecular Sieves, Taiyuan University of Technology, China, 2010]. Under the measuring conditions (0° C., 30° and 50° C., maximum 3.25 bar), a maximum chlorine uptake capacity of <0.2 g of chlorine per g of storage material was measured. In all these cases, the chlorine uptake capacity is still too low for industrial use and still too expensive for industrial application.

A short processing time is additionally of great importance for commercial application of chlorine stores on an industrial scale; the chlorine adsorption time and also the desorption time are therefore to be as short as possible.

In U.S. Pat. No. 5,376,164A1 it is described that approximately 2 hours are required until the adsorbent has taken up the chlorine and no further increase in weight takes place. The necessary time for desorption is not described in greater detail. For an industrial application, this is disadvantageous in respect of the technical outlay and the costs associated therewith. An adsorption and desorption time on a minute scale would therefore be desirable.

The pressure swing adsorption process is currently not yet being used commercially for chlorine recovery.

The object of the present invention is to provide a storage material based on silicon dioxide for a method for chlorine storage, which storage material is able to take up large amounts of chlorine by adsorption and is available in a simple manner. It is also to be possible to use the storage material to isolate and recover chlorine from process gases in a simple manner.

A specific object of the invention is to provide a storage material which has a substantially higher chlorine uptake capacity than the adsorbents described hitherto (i.e. at least a capacity of 0.4 g of chlorine per g of storage material) in order thus to avoid cost disadvantages upon commercial implementation. The storage material must in particular additionally be both chemically and structurally stable towards corrosive chlorine. Preferably, the adsorption of chlorine on this storage material is to be reversible, in order to make as much chlorine as possible usable again. In addition, the adsorption and the desorption of chlorine on this storage material are in particular to be able to take place more quickly than in the case of known storage material, in order to permit commercial application.

Surprisingly, it has been found that silicon dioxide in nanoporous form with an open-pore structure, in the pore diameter range of <10 nm, preferably in combination with larger pores with a pore diameter of at least 20 nm, which can be formed, for example, by particle interspaces, and a degree of condensation of at least 0.91, is outstandingly suitable for taking up chlorine in large amounts. The uptake capacity of up to >1 g of chlorine per g of storage material that is thereby achieved is far superior to that of the adsorbents described hitherto. In addition, this storage material in particular meets further criteria such as corrosion stability towards chlorine, reversibility of the chlorine adsorption and rapid adsorption and desorption on a minute scale.

The invention provides a porous storage material for the reversible storage of chlorine in liquid phase based on particles of silicon dioxide, in which the particles have pores with a pore diameter of <10 nm, with a maximum in the pore diameter distribution in the range of from 1 nm to 8 nm. preferably in the range of from 1.5 to 2.5 am, and the silicon dioxide is present with a degree of condensation, determined by means of silicon-29 solid-state NMR spectroscopy, of at least 0.91, preferably of at least 0.94.

Surprisingly, it has likewise been found that adsorption on this storage material permits the liquefaction of chlorine within the pores at a lower pressure or a higher temperature than the conditions of the corresponding vapor pressure curve for pure chlorine, which for the purposes of purification, storage and transport as described above brings with it advantages in terms of energy consumption, costs and safety.

It has additionally surprisingly been found in particular that the adsorption of chlorine on this storage material takes place wholly reversibly, which is advantageous in respect of a swing adsorption analogously to the PSA process known in principle from the prior art and in the recovery of chlorine from chlorine-containing process gases.

Furthermore, it has been found, surprisingly, that both the loading of the novel storage material with chlorine and the unloading thereof in particular exhibit more rapid kinetics, that is to say take place on the minute scale. It has additionally been found here that the adsorption kinetics is additionally accelerated in the case of storage materials which have pores with a maximum of the pore distribution in the size range of <10 nm in combination with larger pores with a pore diameter of ≥20 nm. These additional larger pores can result from the particle interspaces which form when particles with a particle diameter of less than 1 μm are present.

A preferred storage material is characterized in that the silicon dioxide particles have a particle diameter in the range of from 30 nm to 2 μm, preferably from 100 nm to 1 μm. In a further preferred embodiment of the invention, the particles have a mean particle diameter in the range of from 200 nm to 1 μm, preferably from 300 nm to 700 am.

A particularly preferred form of the storage material comprises silicon dioxide particles which already have a loading capacity of at least 0.4 g of chlorine/g of storage material, preferably at least 0.6 g of chlorine/g of storage material, particularly preferably at least 1 g of chlorine/g of storage material, at 0° C. and not more than 3 bar.

A preferred form of the storage material is especially characterized in that the time taken to load the storage material with chlorine is <40 minutes and the time taken to unload the chlorine is <60 minutes, based on 1 g of chlorine per g of material, measured at −26° C. and 1 bar.

For practical applications, in a preferred embodiment of the invention the silicon dioxide particles of the above-described storage material are packed with one another three-dimensionally to form a storage body.

A preferred form of the above-mentioned storage body is characterized in that the storage body has additional pores with a pore diameter of at least 20 nm, preferably in the range of from 20 nm to 2 μm. These additional pores serve as transport pores which facilitate the loading of the material with chlorine in order thus to reduce the loading time.

The storage material according to the invention and the storage bodies according to the invention are advantageously used to form a storage system for the reversible storage of chlorine.

The invention therefore also provides a storage system for the reversible storage of chlorine in liquid phase, at least comprising a feed pipe for a chlorine-containing gas, a discharge pipe for chlorine-containing gas, optionally a discharge pipe for residual gas separated from the chlorine, a thermally insulated pressure vessel which is filled with a storage material based on silicon dioxide for the adsorption of chlorine, characterized in that there is provided as the storage material a novel storage material described herein or a novel storage body described herein.

By means of the novel storage material, a novel method for the reversible storage of chlorine in liquid phase is also made possible.

The invention therefore also provides a method for the reversible storage of chlorine in liquid phase, which method comprises at least the following method steps:

Feeding of a chlorine-containing process gas to a storage material which is maintained at a temperature of not more than 40° C. at a pressure of from 0.25 bar to 10 bar, then either desorption of the stored chlorine by the passage of inert gas through the storage material or desorption of the stored chlorine by either reducing the pressure across the storage material or by increasing the temperature of the storage material, characterized in that there is used as the storage material a novel storage material described herein or a novel storage body described herein.

Preferably, the novel storage method is carried out in a novel storage system described above.

The invention also provides the use of porous silicon dioxide material for taking up chlorine in large amounts (>0.4 g per g of storage material) under conditions with lower pressures or higher temperatures than the boiling point of chlorine (e.g. p<7 bar at room temperature or T>−35° C. at atmospheric pressure), which material comprises at least pores with pore diameters in the size range of <10 nm. Preferably, storage materials are used which have pores with pore diameters in the size range of <10 nm in combination with larger pores with pore diameters >20 nm.

Preference is given to the use of the novel porous storage material or of a novel storage body as described above for the adsorption of chlorine with the aim of separating chlorine from process gases containing chlorine. Preferably, the process gas in this use contains, in addition to chlorine, gases such as hydrogen, oxygen, nitrogen or inert gases such as argon and helium. Such gases are not condensable under the storage conditions (storage temperature T>−35° C. at atmospheric pressure). Particular preference is given to the process gas consisting of the residual gas of a process for chlorine liquefaction, which contains as the main constituents chlorine, hydrogen and oxygen.

The process gas can preferably also be the gas that is obtained from the catholyte chamber of an HCl diaphragm electrolysis and contains at least hydrogen and chlorine.

In another form of use, the process gas is the waste gas, containing at least oxygen and chlorine, from a gas-phase oxidation process for the reaction of hydrogen chloride with oxygen.

The invention preferably further also provides the use of the novel porous storage material or of a novel storage body as described above for the liquefaction of chlorine for the purification, storage or operationally safe transport of liquid chlorine.

In particular, storage materials suitable for use for the uptake of chlorine in large amounts under conditions with a lower pressure or higher temperature than the boiling point of chlorine (e.g. p<7 bar at room temperature or T>−35° C. at atmospheric pressure) are those which have a degree of condensation of at least 0.91 (determined by means of silicon-29 solid-state NMR spectroscopy) and as a result have high chemical and structural resistance to chlorine. Other silicon dioxide storage materials having a degree of condensation of not more than 0.90 (determined by means of silicon-29 solid-state NMR spectroscopy) do not have sufficient stability for the use according to the invention since structural and/or chemical changes through contact with chlorine can be observed.

The invention is explained in greater detail below with reference to the examples and figures, which, however, are not intended to limit the invention.

In the Figures:

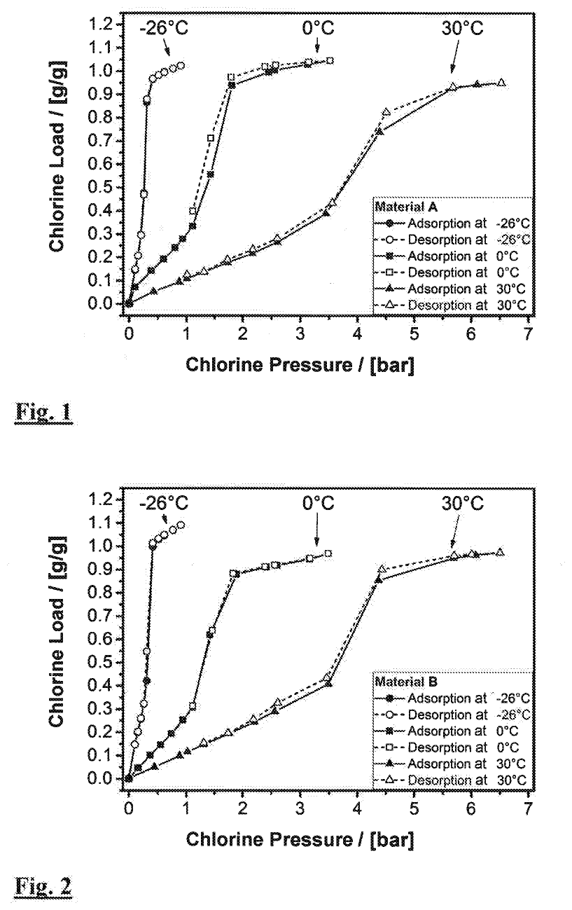

FIG. 1 shows the chlorine storage isotherms of silicon dioxide storage material A according to the invention at −26° C., 0° C. and 30° C. Storage material A consists of SiO₂ with a mean pore diameter of between 1.4 nm and 3.4 nm, and a particle diameter of approximately from 100 nm to 800 nm.

FIG. 2 shows the chlorine storage isotherms of silicon dioxide storage material B according to the invention at −26° C., 0° C. and 30° C. Storage material B consists of SiO₂ with a mean particle diameter of between 1.8 nm and 3.2 nm, and a particle diameter of approximately from 300 nm to 1 μm.

FIG. 3 shows the time-dependent chlorine adsorption on silicon dioxide storage materials A and B according to the invention at −26° C.

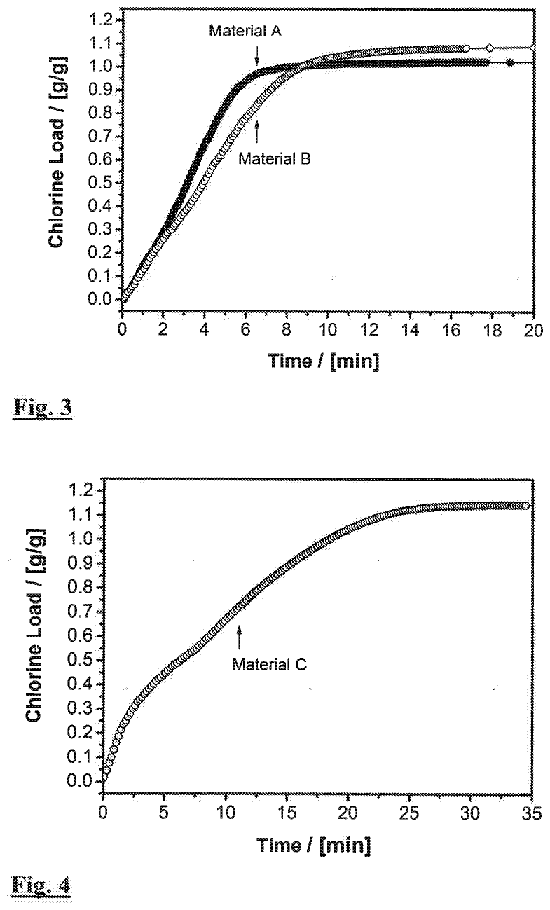

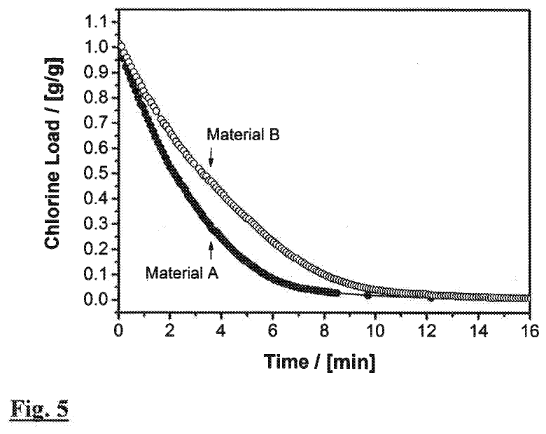

FIG. 4 shows the time-dependent chlorine adsorption on a comparative silicon dioxide storage material C with larger particles than materials A and B, Comparative material C consists of SiO₂ with a mean pore diameter of between 5.5 nm and 8 nm, and a particle diameter of approximately from 1 nm to 1.5 μm.

FIG. 5 shows the time-dependent chlorine desorption of silicon dioxide storage materials A and B according to the invention at −26° C.

### EXAMPLES

### Example 1

Two storage materials which permit higher loading than in the prior art were produced as follows:

Material A: Material A consists of SiO₂ with a mean pore diameter of between 1.4 nm and 3.4 nm, and a particle diameter of approximately from 100 nm to 800 nm.

Production was carried out according to the following formulation: With stirring at room temperature, 87.5 ml of ethanol and 70.3 ml of deionized water were mixed with 7.9 ml of aqueous ammonia solution (25% by weight). 2.83 g of cetyltrimethylammonium bromide were added and dissolved by stirring for 10 minutes at room temperature. With stirring, 5.42 g of tetraethyl orthosilicate were added quickly and stirred for a further 2 hours. The colorless solid which formed was separated off by centrifugation (10 min at 6000 min⁻¹). The solid was redispersed in 40 ml of ethanol and separated off by centrifugation (10 min at 6000 min⁻¹). Then the solid was stored in air for 16 hours at 50° C. and then calcined in air for 15 hours at 500° C. The resulting storage material consisted of spherical particles with particle diameters of approximately from 100 nm to 800 nm. It had an internal surface area of A_{BET}=1161±23 m²/g and a pore volume of Vₚ=0.83 cm³/g. The diameter of the pores was between 1.4 nm and 3.4 nm, with a maximum of the pore diameter distribution at 2.3±0.5 nm. A further batch of the material had, divergently, an internal surface area of A_{BET}=1536±97 m²/g and a pore volume of Vₚ=0.70 cm³/g.

Material B: Material B consists of SiO₂ with a mean pore diameter of between 1.8 nm and 3.2 nm, and a particle diameter of approximately from 300 nm to 1 μm.

Production was carried out according to the following formulation: With stirring at room temperature, 1.75 g of cetyltrimethylammonium bromide were dissolved in 411.6 ml of deionized water. To the solution there were added 31.6 ml of aqueous ammonia solution (25% by weight), and stirring was carried out for 20 minutes at room temperature. With stirring, 8.33 g of tetraethyl orthosilicate were added quickly. Stirring was carried out for 5 hours at room temperature. The resulting colorless solid was separated off by filtration, washed with 50 ml of water and dried for 24 hours at 105° C. It was then calcined in air for 15 hours at 500° C. The resulting storage material consisted of particles with particle diameters of approximately from 300 nm to 1 μm. It had an internal surface area of A_{BET}=1036±5 m²/g and a pore volume of Vₚ=0.78 cm³/g. The diameter of the pores was between 1.8 nm and 3.2 nm, with a maximum of the pore diameter distribution at 2.5±0.3 nm.

In order to study the chlorine storage capacity of the storage materials, chlorine adsorption isotherms were recorded. In order to measure the adsorption of chlorine on the material, approximately 200 mg of storage material were heated thoroughly at 2×10⁻³ bar and 150° C. in a magnetic suspension balance. For defined temperatures and chlorine pressures, the increase in mass of the sample was measured, whereby adsorption isotherms were obtained.

FIG. 1 shows the adsorption and desorption isotherms of chlorine on material A at −26° C., 0° C. and 30° C. FIG. 2 shows the adsorption and desorption isotherms of chlorine on material B at −26° C., 0° C. and 30° C. It can be seen from the isotherms that the materials have a chlorine storage capacity of over 1 g of chlorine per 1 g of storage material. They are thus significantly superior to the materials described in the prior art having a storage capacity of up to 0.26 g of chlorine per 1 g of material. The storage isotherms additionally show that, even at low pressures, considerable chlorine adsorption takes place. The materials exhibit, for example, at a temperature of 0° C. and a pressure of 3 bar, a load of more than 0.4 g of chlorine per 1 g of storage material. Under the same conditions, the load of chlorine on SiO₂ materials in [W. Q. Xiao, dissertation, Chlorine Adsorption Properties of NaX, NaY, MCM-41, MCM-48 and Mordenite Molecular Sieves, Taiyuan University of Technology, China, 2010] is below 0.2 g of chlorine per 1 g of material.

The adsorption of chlorine on the storage materials is wholly reversible, as can be seen from the almost matching curves of the adsorption isotherms (filled symbols in FIGS. 1 and 2) with the corresponding desorption isotherms (unfilled symbols in FIGS. 1 and 2) at maximum and minimum loading.

### Example 2

The storage materials permit liquefaction of chlorine in the pores at a temperature higher than −35° C. at atmospheric pressure, or at a pressure lower than 6.8 bar at room temperature, as can be concluded from a comparison of the density of the adsorbed chlorine with the densities of liquefied and gaseous chlorine under the same conditions:

At a temperature of T=−26° C. and p_{chlorine}=0.90 bar, an average density of the adsorbed chlorine of ρ=1.47 g/cm³ is obtained for material A with an adsorbed mass m_{ads}=1.03 g/g and a pore volume of Vₚ=0.70 cm³/g. Under the same conditions, an average density of the adsorbed chlorine of ρ=1.40 g/cm³ is observed for material B with an adsorbed mass m_{ads}=1.09 g/g and a pore volume of Vₚ=0.78 cm³/g. Since under these conditions liquid chlorine has a density of 1.53 g/cm³ and gaseous chlorine has a density of 0.003 g/cm³, the chlorine in the pores is for the most part in liquid form.

Analogously, for a temperature of T30=30° C. and p_{chlorine}=6.53 bar, an average density of the adsorbed chlorine of ρ=1.14 g/cm³ can be observed for material A with an adsorbed mass m_{ads}=0.95 g/g and a pore volume of Vₚ=0.83 cm³/g. For material B, an average density of the adsorbed chlorine of ρ=1.24 g/cm³ is obtained at T=30° C. and p_{chlorine}=6.50 bar with an adsorbed mass m_{ads}=0.97 g/g and a pore volume of Vₚ=0.78 cm³/g. The density of liquid chlorine under these conditions is 1.38 g/cm³, while the density of gaseous chlorine is 0.003 g/cm³. Consequently, here too a large part of the adsorbed chlorine is in liquid form.

### Example 3

In order to study the kinetics of the loading of the storage materials, approximately 150 mg of storage material were heated thoroughly at 0.01 bar and 150° C. The storage material was introduced into a magnetic suspension balance and nitrogen was circulated around it at T=95° C. and p=1 bar with a gas stream of 150 sccm until a constant weight was obtained. At T=−26° C., p=1 bar and a total gas stream of 150 sccm, defined volume fractions of the gas stream were replaced by chlorine. In order to study the adsorption kinetics, the volume fraction of chlorine in the gas stream was increased from 0 vol. % to 88.5 vol. % and the time-dependent increase in mass was measured.

The loading of materials A and B largely follows a limited linear growth (see FIG. 3). For complete loading with chlorine, lengths of time of approximately from 10 to 20 minutes are required. The rapid loading of the materials is based on the ready accessibility of the storage pores (diameter<10 nm) through additional larger transport pores (diameter>20 nm), for example formed by corresponding particle interspaces in the case of particle diameters below 1 μm.

A material C in which the particle diameters are larger was produced. The number of larger transport pores in relation to the smaller storage pores is thereby reduced significantly.

Material C: C consisting of SiO₂ with a mean pore diameter of between 5.5 nm and 8 nm, and a particle diameter of approximately from 1 μm to 1.5 μm.

Production of material C takes place analogously to [J. Am. Chem. Soc., 1998, 120 (24), pp. 6024-6036]. With stirring at room temperature, 4.0 g of poly(ethylene glycol)-block-poly-(propylene glycol)-block-poly(ethylene glycol) (Mₙ˜5800, trade name Pluronic P123) were dissolved in a mixture of 30 ml of water and 130 ml of aqueous HCl (2.0 M). 8.5 g of tetraethyl orthosilicate were added to the solution, and the solution was stirred for a further 5 minutes at room temperature. Then the solution was heated for 18 hours at 35° C. and then for 24 hours at 80° C. The resulting colorless solid was filtered off, washed twice with 50 ml of water and once with 50 ml of ethanol, and then calcined in air for 30 hours at 500° C. Material C consisted of SiO₂ particles with particle diameters of approximately from 1 μm to 1.5 μm, an internal surface area of A_{BET}=656±3 m²/g and a pore volume of Vₚ=0.77 cm³/g. The diameter of the storage pores was between 5.5 nm and 8 nm, with a maximum of the pore diameter distribution at 6.6±1.0 nm.

The loading kinetics of sample C is shown in FIG. 4. For maximum loading, sample C requires at least 20 minutes, whereas the maximum load in the case of A and B is achieved in a time of approximately 10 minutes. The smaller number of transport pores in relation to the storage pores consequently leads in the case of material C to significantly slower loading of the material.

The study of the desorption kinetics was carried out analogously to the study of the adsorption kinetics, wherein the volume fraction of chlorine in the gas stream was lowered from 88.5 vol. % to 0 vol. % and the time-dependent increase in mass was measured.

The unloading of materials A and B corresponds largely to an exponential decrease in the adsorbed chlorine (see FIG. 5). Complete unloading of materials A and B takes place within a period of 20 minutes.

### Example 4

In order to study the structural and chemical stability of the materials towards chlorine, the materials were brought into contact with chlorine and then characterized again. A degree of condensation of greater than 0.91 was thereby identified as an important parameter for high stability. The determination of the degree of condensation of the SiO₂ materials in the examples here took place by silicon-29 solid-state NMR spectroscopy (magic angle spinning at 10 kHz). By deconvolution and integration of the signals of the various Qⁿ centers (Qⁿ=Si(OSi)ₙ(OH)₄₋ₙ), the proportions of the corresponding centers in the materials were determined. The degree of condensation of the materials is given as the proportion of Si—OSi bonds in all the Si—OR bonds (degree of condensation=(number of Si—OSi bonds)/(number of Si—OR bonds in total)).

Material A with a degree of condensation of 0.95 and material B with a degree of condensation of 0.92 did not exhibit any structural changes even after repeated full loading and unloading with chlorine. The absence of chlorine in storage materials A and B after the treatment could be demonstrated by energy-dispersive X-ray spectroscopy. Irreversible reactions of the storage materials with chlorine during the treatment can thus be ruled out.

A comparative material D which has a lower degree of condensation and as a result does not have sufficient chlorine stability was produced.

Comparative material D: Material D consists of SiO₂ in the form of aerogel with a degree of condensation of 0.90.

Production of comparative material D: At room temperature, 4.0 ml of tetramethyl orthosilicate were dissolved in 3 ml of methanol. With vigorous stirring, a solution of 2.0 ml of 0.1 M aqueous ammonia and 3.0 ml of methanol was added quickly, and stirring was carried out for a further 1 minute at room temperature. The gel which had formed after 20 minutes was stored for 1 day at room temperature. Then the solvent in the gel was replaced by covering with a layer of acetone. In an autoclave, the solvent in the gel was replaced by covering with a layer of liquid CO₂ (62 bar, room temperature). By increasing the temperature to over 40° C. (p>80 bar), the CO₂ was brought into the supercritical state. Then the pressure was lowered to normal pressure at approximately 5 bar/h and the material was removed.

Comparative material D with a degree of condensation of 0.90 exhibited considerable structural changes after only 30 minutes' contact with a chlorine gas stream at room temperature and normal pressure. The internal surface area (A_{BET}) fell from 820±3 m²/g to 649±1 m²/g, while the pore volume (Vₚ) increased from 1.95 cm³/g to 3.14 cm³/g. By means of IR spectroscopy it was possible to observe inter alia a decrease in OH vibrations relative to SiO vibrations. It follows therefrom that chemical reactions have taken place in the material.

1.-16. (canceled)

17. A porous storage material for the reversible storage of chlorine in liquid phase based on particles of silicon dioxide, in which the particles have pores with a pore diameter of <10 nm, with a maximum in the pore diameter distribution in the range of from 1 nm to 8 nm, and the silicon dioxide is present with a degree of condensation, determined by means of silicon-29 solid-state NMR spectroscopy, of at least 0.91.

18. The storage material as claimed in claim 17, wherein the particles have a particle diameter in the range of from 30 nm to 2 μm.

19. The storage material as claimed in claim 17, wherein the particles have a mean particle diameter of from 200 nm to 1 μm.

20. The storage material as claimed in claim 17, wherein the particles, measured at 0° C. and not more than 3 bar, preferably measured at 0° C. and not more than 2 bar, have a loading capacity of at least 0.4 g of chlorine/g of storage material.

21. The storage material as claimed in claim 17, wherein the time taken to load the storage material is <40 minutes (based on 1 g of chlorine per g of material) and the time taken for unloading is <60 minutes (based on 1 g of chlorine per g of material).

22. A storage body comprising a storage material as claimed in claim 17, wherein the particles are packed 3-dimensionally in the storage body.

23. The storage body as claimed in claim 22, wherein the storage body has additional pores with a pore diameter of at least 20 nm.

24. A storage system for the reversible storage of chlorine in liquid phase, at least comprising a feed pipe for a chlorine-containing gas, a discharge pipe for chlorine-containing gas, optionally a discharge pipe for residual gas separated from the chlorine, a thermally insulated pressure vessel which is filled with a storage material based on silicon dioxide for the adsorption of chlorine, wherein there is present as the storage material a storage material as claimed in claim 17.

25. A method for the reversible storage of chlorine in liquid phase, comprising at least the following method steps:
feeding of a chlorine-containing process gas to a storage material which is maintained at a temperature of not more than 40° C. at a pressure of from 0.25 bar to 10 bar, then either desorption of the stored chlorine by the passage of inert gas through the storage material or desorption of the stored chlorine by either reducing the pressure across the storage material or by increasing the temperature of the storage material, wherein there is used as the storage material a storage material as claimed in claim 17.

26. The method as claimed in claim 25, wherein the method is carried out in a storage system as claimed in claim 24.

27. The use of the porous storage material as claimed in claim 17 or of a storage body as claimed in claim 22 for the adsorption of chlorine for the purpose of separating chlorine from chlorine-containing process gases.

28. The use as claimed in claim 27, wherein the process gas, in addition to chlorine, contains gases such as hydrogen, oxygen, nitrogen or inert gases such as argon and helium.

29. The use as claimed in claim 27, wherein the process gas is the residual gas, containing at least hydrogen, chlorine and oxygen, of a chlorine liquefaction.

30. The use as claimed in claim 27, wherein the process gas is the gas, containing at least hydrogen and chlorine, from the catholyte chamber of an HCl diaphragm electrolysis.

31. The use as claimed in claim 27, wherein the process gas is the waste gas, containing at least oxygen and chlorine, from a gas-phase oxidation process for the reaction of hydrogen chloride with oxygen.

32. The use of the porous storage material as claimed in claim 17 or of a storage body as claimed in claim 22 for the liquefaction of chlorine for the purification, storage or operationally safe transport of liquid chlorine.
